(19) United States
(12) Patent Application Publication
(10) Pub. No.: US 2006/0004939 A1
(43) Pub. Date: Jan. 5, 2006

(54) Mechanism to control infrared devices via a universal plug and play device network

(76) Inventors: James W. Edwards, Portland, OR (US); Ylian Saint-Hilaire, Hillsboro, OR (US); Bryan Y. Roe, Camas, WA (US); Nelson F. Kidd, Camas, WA (US); Pronay Dutta, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,366

(22) Filed: Jun. 30, 2004

(51) Int. Cl. G06F 13/12; G06F 13/00

(52) U.S. Cl. 710/302; 710/62

(57) ABSTRACT

According to one embodiment, a system is disclosed. The system includes a first Universal Plug and Play (UPnP) device having an infrared (IR) service to transmit IR commands and a first IR device to receive the IR commands from the first UPnP device and perform actions associated with the received commands.

### FIELD OF THE INVENTION

The present invention relates to the field of networking, and, more particularly to Universal Plug and Play (“UPnP”) systems.

### BACKGROUND

Universal Plug and Play (“UPnP”) systems provide an architecture for peer-to-peer network connectivity. UPnP-compliant devices may dynamically join a network, obtain a network address, convey their capabilities to the network and learn about the presence and capabilities of other devices on the network. UPnP control points control UPnP devices by requesting the devices to perform specified actions (“services”).

UPnP services are defined for specific types of devices such as printers or Audio-Visual (AV) equipment and the defined service interfaces enable actions to be invoked by a control point and events to be returned to a control point. For example, a UPnP AV service for rendering devices addresses rendering control actions such as setting volume, mute, display contrast, etc.

Many use cases for controlling UPnP devices via portable devices such as laptops and PDAs involve first powering equipment up and invoking the UPnP actions supported by the UPnP device and services implemented by the equipment. Before a UPnP device can be controlled, it must be discovered on the home network. If a UPnP device is not powered up, it cannot be discovered. Therefore, the simple operation of powering up a device cannot be supported for UPnP devices. A user will not understand why control of various operations on a UPnP device are possible such as volume, while others such as the simple operation of powering a device up are not available.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a Universal Plug and Play (UPnP) network;

FIG. 2 is a flow diagram illustrating one embodiment of operating a device via IR;

FIG. 3 is a flow diagram illustrating another embodiment of operating a device via IR; and

FIG. 4 is a flow diagram illustrating one embodiment of device discovery.

### DETAILED DESCRIPTION

A mechanism to control infrared devices via the UPnP device architecture is described. In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same.

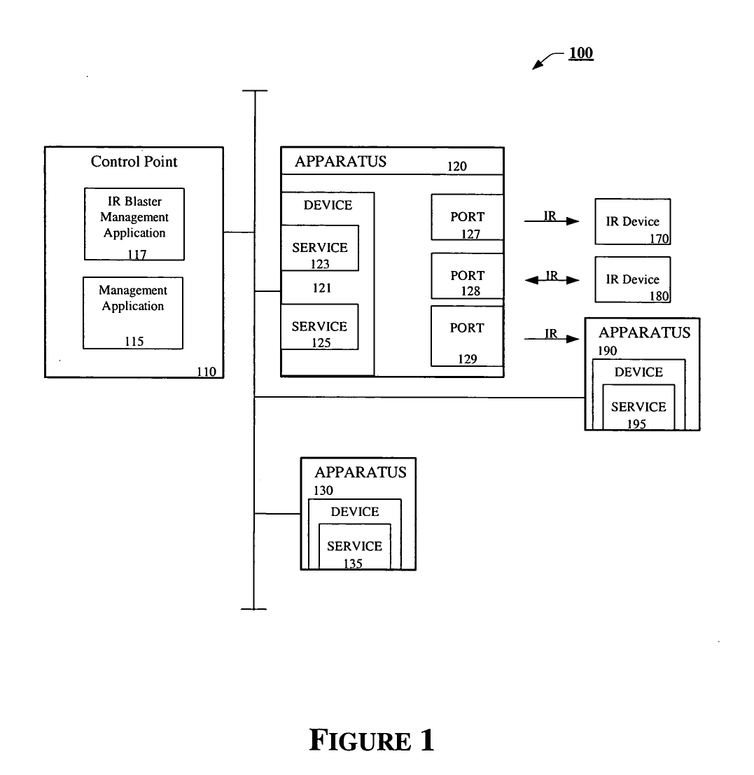

FIG. 1 illustrates one embodiment of a UPnP device network 100. Network 100 includes control point 110 and apparatuses 120, 130 and 190. Apparatuses 120, 130 and 190 may represent a unit, such as a personal computer, a television, a digital camera, or any other suitable unit. Each apparatus may include at least one device. As used herein, a device is an object that is abstracted within an apparatus. A device may include services and/or other device objects. A service is an object that is abstracted within a device.

As shown in apparatuses 120, 130 and 190, an apparatus may include one or more device(s), and each device may include several services. In one embodiment, apparatus 120 is implemented in a Digital Media Adapter. In another embodiment, apparatus 120 is a stand-alone device that is used to blast IR signals to devices in its vicinity.

According to one embodiment, apparatus 120 enables the ability to power up/down and the general control of both UPnP and non-UPnP devices that support IR remote control. Device 121 is an infrared (IR) discovery device having services 123 and 125. In one embodiment, service 123 is an IR blaster service, and service 125 is an IR discovery service, both of which will be discussed in more detail below. In contrast, apparatus 130 may be a handheld device that includes remote control service 135, while apparatus 190 may be a digital video disk (DVD) apparatus that includes playback service 195. Note that in other embodiments, apparatus 130 may be implemented with any device capable of transmitting IR codes (e.g., a laptop).

Apparatus 120 also includes ports 127 and 128. In one embodiment, ports 127 and 128 enable apparatus 120 to control the operations of the devices 170 and 180, which are not associated with network 100, via IR. In a further embodiment, either port 127 or 128, or both, may be a two-way IR port. Port 129 is associated with apparatus 190. Port 129 may be used to power up and control apparatus 190 even though apparatus 190 is on network 100.

The services provided by a particular type of device differ among device types. Accordingly, a device may maintain and selectively provide a listing of the service(s) and/or other information pertaining to the individual device. According to one embodiment, a device hosts an extensible Markup Language (XML) description document that describes the services provided by the device as well as other associated information.

Control point 110 includes a management application 115 that is implemented to manage the various services. In one embodiment, control point 110 invokes actions of services that are embedded in disparate devices (and apparatuses). Control point 110 may be used to discover and control UPnP devices in network 100.

In one embodiment, control point 110 may discover a device (e.g., device 130 or 121), receive an XML description associated with the device, retrieve descriptions of services associated with the device based on pointers located in the description, invoke actions specified in the service descriptions, and subscribe to events issued by the services.

In the latter regard, a service will send an event to the control point when a state of the service changes. A service description may also include a list of variables that model the state of the service at run time. UPnP messages may be delivered via Hyper Text Transport Protocol (“HTTP”) or User Datagram Protocol (“UDP”) or any other of a number of protocols, possibly running over Internet Protocol (“IP”).

According to one embodiment, control point 110 includes an IR blaster management application 117 that manages blaster service 123 at apparatus 120. Blaster service 123 issues IR commands to a device via one or more output ports (e.g., port 129) associated with IR controlled UpnP devices, or via ports 127 and 128 interface services associated with non-UPnP devices.

In one embodiment, blaster service 123 stores data corresponding to the existence of one or more UPnP devices, even when those devices are powered down. In addition, blaster service 123 stores data corresponding to the existence of one or more non-UPnP devices.

In a further embodiment, IR blaster service 123 offers information on the room in which it is located, and actions that allow that information to be changed. Further, IR blaster service 123 may use the normal UPnP discovery mechanisms to find a UPnP device (e.g., apparatus 190) when a device is first powered up by a user (via the local power on/off switch on a device's front panel) and remembers the device description information (also discoverable by UPnP mechanisms).

If a given UPnP device is subsequently powered down, blaster service 123 may proxy for the device to enable discovery of the device by blaster management application 117. IR blaster service 123 may then subsequently power up such devices via IR, upon which a newly powered up UPnP device would then be able to respond over the network to the normal UPnP actions it supports.

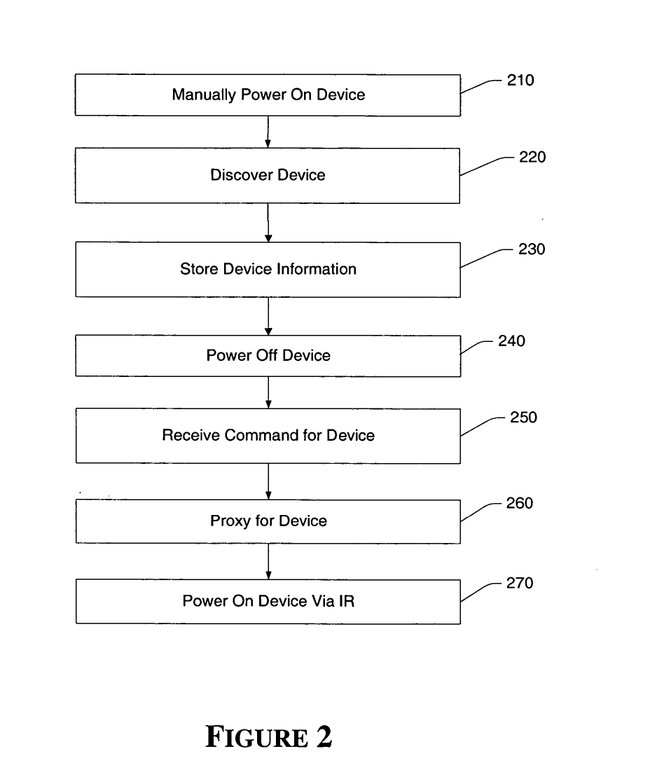

FIG. 2 is a flow diagram illustrating one embodiment of operating a device via IR. At processing block 210, a device is manually powered on by the device user. At processing block 220, the device is discovered by network 100 using common UPnP device mechanisms. At processing block 230, blaster service 123 stores data corresponding to the device description information, including IR information.

Some time after storing the description information, the device is powered down, processing block 240. At processing block 250, a command is received at blaster service 123 for the device. At processing block 260, blaster service 123 proxies for the device to enable the device to be discovered. At processing block 270 blaster service 123 powers up the device by IR via the corresponding output port.

Referring back to FIG. 1, IR blaster service 123 may generate an IR command via UPnP actions received from network 100, and transmit the IR command to a network device via a corresponding output port. In one embodiment, a user configures an association between an output port and a device using blaster management application 117 at control point 110.

In a further embodiment, the user enters other information such as an associated device manufacturer, model number, the location of the device in the home, etc. If the control point 110 blaster management application 117 runs on a platform such as a PC, the product information enables blaster management application 117 to consult an IR code database within control point 110 to determine a specific IR code needed to power up/down a device, and any other specific controlling functions that may go beyond the level of control allowed via defined UPnP device services and actions.

As discussed above, IR blaster service 123 also supports non-UPnP devices that support IR remote control. According to one embodiment, the IR code database represents such devices as appropriate UPnP devices and proxy the devices on to the network 100 as UPnP devices.

In another embodiment, IR controllable devices are defined as another form of UPnP device where the mapping between IR codes and the specific operations supported by a device are discoverable. In such an embodiment, blaster management application 117 directly presents the information discovered through UPnP to a user at apparatus 120 for control purposes.

For example, the information presented to the user at apparatus 120 may be presented to a user in menu form indicating various devices that are listed by home location. Consequently, the user may select a device based upon which room in the home the user is currently located. Once the user selects a particular device to control, the user may be presented with further menu options in the form of the discovered names for each controlling operation such as volume up, volume down, channel up, channel down, etc.

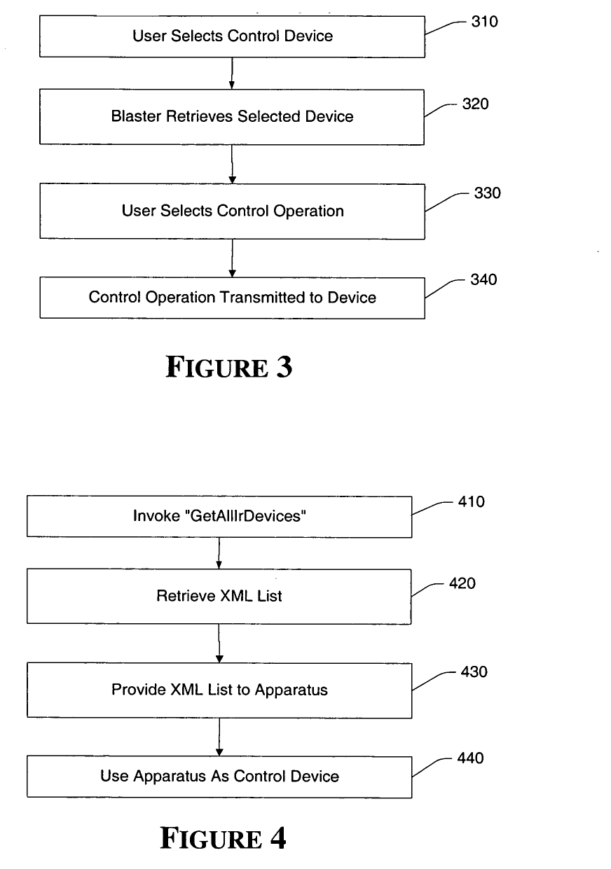

FIG. 3 is a flow diagram illustrating one embodiment of operating a device via IR. At processing block 310, a user selects a device to control at apparatus 120. At processing block 320, blaster service 123 retrieves the selected device ID codes from the IR database. At processing block 330, the user selects a control operation for the selected device. At processing block 340, the control operation is transmitted to the device in IR form.

According to one embodiment, an IR device supports two-way IR, which would enable the state of the device to also be retrieved via a defined UPnP service interface (e.g., ports 127 or 128). IR blaster service 123 in such an embodiment would operate as an IR receiver to detect changes of state and forward them on to network 100 as UPnP events or allow the state to be retrieved via UPnP actions. If IR blaster service 123 supports two-way IR communication, the IR receive portion may be shutoff using a UPnP action in the blaster service 123 (e.g., power saving feature). The IR power setting could be set using an action in blaster service 123.

According to a further embodiment UPnP Security can be used to add privacy and authentication to IR blaster service 123. In such an embodiment, UPnP Security may be implemented to control access of IR blaster management application 117 to actions that may be invoked for each IR device. Security may be set so that control points other than control point 110 may use blaster service 123 but not configure blaster service 123. For instance, UPnP security allows device 121 to determine which instances control point 110 may use services 123 and 125. If control point 110 is allowed to use service 123 or service 125, services 123 and 125 may prescribe limitations on what actions can be called.

In a further embodiment, apparatus 120 features the automatic discovery of device IR codes. Referring back to FIG. 1, discovery service 125 enables applications in network 100 to discover IR remote control codes for devices such as devices 170 and 180 and apparatus 190 that accept and respond to IR codes.

In one embodiment, discovery service 125 may discover devices 170 and 180 after a network user verifies the existence of the devices. In addition, devices 170 and 180 may directly report their existing by responding over 2-way IR. Similarly, device 190 may report its existence via UPnP. The discovered codes may be used by blaster service 123 to control devices as described above. However in one embodiment, apparatus 130 may use the codes to control IR devices.

As discussed above, apparatus 130 may be a handheld device (e.g., a pocket PC, wireless laptop or PDA) that can discover the IR codes associated with each IR device in any room. Once the correct IR codes are discovered and saved, apparatus 130 may be moved between rooms and used to control each device.

According to one embodiment, discovery service 125 exposes discoverable UPnP devices on network 100. Discovery service 125 includes an action (“GetAllIrDevices”) that when invoked by management application 115 returns an XML list of all IR devices. The list is stored in a discovery database at control point 110. In one embodiment, control point 110 may retrieve only a certain number of devices for each call to the GetAllIrDevices action. For example, the retrieval processes may start at listed device number twenty and retrieve the next ten devices.

FIG. 4 is a flow diagram illustrating one embodiment of IR device discovery. At processing block 410, the GetAllIrDevices action is invoked at discovery service 126. At processing block 420, discovery service 126 retrieves a XML document including a list of one or more IR devices from the discovery database at control point 110. At processing block 430, the XML document is provided to apparatus 130. At processing block 440 apparatus 130 may be used as an IR control device.

According to one embodiment, each node in the XML list includes the name, manufacturer, and IR code identifier for that device. In a further embodiment, the XML list includes the name and IR code for each device key, and a key layout grid. In yet a further embodiment, the XML document also includes a URL to a small picture or the IR device (e.g., an icon in Windows or PNG format). In addition, the IR XML device list may also include an icon for the device manufacturer name and a layout bitmap that can be shown to make the handheld device screen resemble the remote control normally used by a particular IR device.

Further, the XML list may include the UPnP unique identifier and UPnP device type of an IR device if the particular device is also discoverable using UPnP. For instance, if a projector on network 100 can accept both UPnP and IR commands, the unique UPnP device identifier for the projector is retrieved from the discovery database. If apparatus 130 is later using that projector and is also connected to network 100, apparatus 130 can match the IR device it is currently using with the UPnP device on network 100.

In one embodiment, management application 115 implements (“CreateNewIrDevice”) and (“DeleteIrDevice” actions) to enable control point 110 to manage the list of IR devices provided by discovery service 126. In such an embodiment, control point 110 can read the device list and add/remove IR devices. Note that the GetAllIrDevices action may have different access privileges than the CreateNewIrDevice or DeleteIrDevice actions.

Moreover, each IR device that is also a UPnP device, such as a network projector, can directly provide its own UPnP IR service in addition to listing itself in the discovery service 125. This device may also provide the information to service 125 by invoking CreateNewIrDevice. However, such a device would generally not implement the CreateNewIrDevice and DeleteIrDevice actions, since the device only provides its own IR codes, layout and icon. In such an embodiment, a user may configure the IR device list manually or by using information available on the Internet. With Internet assistance, icons and key layout templates are easily downloaded.

The above-described blaster service makes it possible to discover the existence of UPnP devices regardless of their power states, and features the ability to power up the devices in the instances in which a device is powered down. In addition, the blaster service enables the control of non-networked IR controllable devices via UPnP, and provides finer grained control of IR controllable UPnP devices.

The IR discovery service facilitates the automation of IR code configuration without having to be manually entered by a user or learned by an IR capable handheld device. Further, the discovery service provides information about an IR device (e.g., manufacturer, icon and button layout) that is typically not collected since it is time consuming.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. A system comprising:
a first Universal Plug and Play (UPnP) device having an infrared (IR) service to transmit IR commands; and
a first IR device to receive the IR commands from the first UPnP device and perform actions associated with the received commands.

2. The system of claim 1 further comprising a second IR device to receive the IR commands from the first UPnP device and perform actions associated with the received commands.

3. The system of claim 2 wherein the IR service maintains data corresponding to the first IR device and the second IR device.

4. The system of claim 3 wherein the IR service maintains location information for the first IR device and the second IR device.

5. The system of claim 2 wherein the IR service proxies for the first IR device and the second IR device whenever the IR devices are powered down to enable discovery of the IR devices.

6. The system of claim 5 wherein the IR service transmits IR commands to the first IR device and the second IR device to power up the IR devices.

7. The system of claim 2 wherein the first IR device is a second UPnP device and the second IR device is a non-UPnP device.

8. The system of claim 7 wherein the first UPnP device comprises an output port associated with the first IR device to transmit the IR commands to the first IR device.

9. The system of claim 10 wherein the IR service generates the IR commands via UPnP actions.

10. The system of claim 8 further comprising a UPnP control point having an application to manage the IR service.

11. A method comprising:
receiving a request at a Universal Plug and Play (UPnP) IR service to access an infrared (IR) device that is offline;
proxying for the IR device at the service to enable the IR device to be discovered;
transmitting an IR command to the IR device; and
powering up the IR device.

12. The method of claim 11 further comprising:
discovering the IR device at the IR service upon installation of the device on a UPnP network; and
storing data corresponding to the IR device description information at the service.

13. The method of claim 12 further comprising retrieving identification codes associated with the IR device from a database prior to upon receiving the request.

14. An apparatus comprising a Universal Plug and Play (UPnP) service to transmit infrared (IR) commands to an IR device that performs actions associated with the transmitted commands.

15. The system of claim 14 wherein the service maintains location information for the IR device.

16. The system of claim 14 wherein the service proxies for the IR device on a UPnP network whenever the IR device is powered down to enable discovery of the IR device.

17. The system of claim 16 wherein the service transmits IR commands to the IR device to power up the IR device.

18. The system of claim 14 wherein the IR device is a second UPnP device.

19. The system of claim 14 wherein the IR device is a non-UPnP device.

20. A storage medium comprising content which when executed by an accessing machine, causes the accessing machine to:
receive a request at a Universal Plug and Play (UPnP) IR service to access an infrared (IR) device that is offline;
proxy for the IR device at the service to enable the IR device to be discovered;
transmit an IR command to the IR device; and
power up the IR device.

21. The storage medium of claim 20 further comprising content which, when executed by the accessing machine causes the accessing machine to:
discover the IR device at the IR service upon installation of the device on a UPnP network; and
store data corresponding to the IR device description information at the service.

22. The storage medium of claim 20 further comprising content which, when executed by the accessing machine causes the accessing machine to retrieve identification codes associated with the IR device from a database prior to upon receiving the request.

23. A system comprising:
a Universal Plug and Play (UPnP) control point to store infrared (IR) codes associated with one or more IR devices;
a first UPnP device having an discovery service to retrieve the IR codes from the control point; and
a second UPnP device to receive the IR codes and to transmit IR commands to the one or more IR devices.

24. The system of claim 23 wherein the discovery service includes a retrieve action that is invoked to retrieve the IR codes from the control point.

25. The system of claim 24 wherein the IR codes are received at the discovery service in the form of an XML list.

26. The system of claim 25 wherein the XML list includes the name, manufacturer and IR code identifier for each IR device.

27. The system of claim 23 wherein the discovery service includes a create action that is invoked to create new IR codes at the control point.

28. The system of claim 23 wherein the discovery service includes a delete action that is invoked to delete IR codes at the control point.
